(19) United States
(12) Patent Application Publication
(10) Pub. No.: US 2024/0054009 A1
(43) Pub. Date: Feb. 15, 2024

(54) PROCESSING SYSTEM, AND INFORMATION PROCESSING APPARATUS AND METHOD

(71) Applicant: Sony Group Corporation, Tokyo (JP)

(72) Inventors: Kazuhiko TAKABAYASHI, Tokyo (JP); Yasuaki YAMAGISHI, Tokyo (JP)

(73) Assignee: Sony Group Corporation, Tokyo (JP)

(21) Appl. No.: 18/552,189

(22) PCT Filed: Mar. 25, 2022
(86) PCT No.: PCT/JP2022/014265

§ 371 Date: Sep. 25, 2023

Related U.S. Application Data
(60) Provisional application No. 63/172,146, filed on Apr. 8, 2021.

(51) Int. Cl. G06F 9/48

(52) U.S. Cl. CPC G06F 9/4843

(57) ABSTRACT

A processing system includes a task management unit that manages a plurality of media processing tasks executed in one or a plurality of servers, in which the task management unit acquires capabilities of a plurality of servers that are possible transition destinations in a case where a media processing task executed in a first server that is one of the plurality of servers is caused to transition to a second server different from the first server, and the capabilities include presence or absence of a persistent storage capable of storing data of the media processing task without depending on an execution state of the media processing task, and location information of the persistent storage. The technology of the present disclosure can be applied to, for example, a media processing system that performs media processing using a 5G network, and the like.

### TECHNICAL FIELD

The present disclosure relates to a processing system and an information processing apparatus and method, and more particularly relates to a processing system and an information processing apparatus and method that enable transition of a media processing task that needs continuity of processing between servers.

### BACKGROUND ART

In recent years, with the spread of Internet streaming, content consumed by streaming and TV broadcasting has been diversified, and media processing for content production therefor is increasingly performed on a cloud. International standards for providing a framework for combining a plurality of various types of media processing for content creation, media processing for optimizing distribution, and the like for implementation on a cloud are being formulated (see, for example, Non-Patent Documents 1 to 3).

On the other hand, in 3GPP which is a standardization organization of a mobile communication standard, a standard requirement for utilizing a 5G network in broadcast content production has been discussed (see, for example, Non-Patent Documents 4 and 5). For example, media processing related to production of relay content from an event venue such as sports or an entertainment live show, or media processing for individualization according to each terminal that consumes content is assumed to be performed on a server (edge server) placed on what is called a network edge. In that case, it is assumed that the optimal edge server for performing each processing changes with movement of the camera as a video source and the terminal consuming the content. In a case where the optimal edge server changes, it is necessary to cause transition of the media processing task being executed in one edge server to another edge server.

### CITATION LIST

### Non-Patent Document

Non-Patent Document 1: ISO/IEC 14496-12:2020, Information technology—Coding of audio-visual objects—Part 12: ISO base media file format
Non-Patent Document 2: ISO/IEC 23090-8:2020, Information technology—Coded representation of immersive media—Part 8: Network based media processing
Non-Patent Document 3: ISO/IEC 23090-8:2020 Amendment 2, Working Draft of ISO/IEC 23090-8 Amendment 2—MPE capabilities, split-rendering support and other enhancements
Non-Patent Document 4: 3GPP TS 26.512 “Technical Specification Group Services and System Aspects; 5G Media Streaming (SGMS); Protocols (Release 16)”
Non-Patent Document 5: 3GPP TS 23.558 “Architecture for enabling Edge Applications (Release 17)”

### SUMMARY OF THE INVENTION

### Problems to be Solved by the Invention

In a case where media processing that needs continuity of processing for a certain period of time is caused to transition between servers, consideration different from that in a case of general asynchronous processing is necessary.

The present disclosure has been made in view of such a situation, and enables transition of a media processing task that needs continuity of processing between servers.

### Solutions to Problems

A processing system according to a first aspect of the present technology includes:
a task management unit that manages a plurality of media processing tasks executed in one or a plurality of servers, in which
the task management unit acquires capabilities of a plurality of servers that are possible transition destinations in a case where a media processing task executed in a first server that is one of the plurality of servers is caused to transition to a second server different from the first server, and
the capabilities include presence or absence of a persistent storage capable of storing data of the media processing task without depending on an execution state of the media processing task, and location information of the persistent storage.

In the first aspect of the present technology, in the task management unit that manages a plurality of media processing tasks executed in one or a plurality of servers, capabilities of a plurality of servers that are possible transition destinations are acquired in a case where a media processing task executed in a first server that is one of the plurality of servers is caused to transition to a second server different from the first server. The capabilities include presence or absence of a persistent storage capable of storing data of the media processing task without depending on an execution state of the media processing task, and location information of the persistent storage.

An information processing apparatus according to a second aspect of the present technology includes:
a task management unit that manages a plurality of media processing tasks executed in one or a plurality of servers, in which
the task management unit acquires capabilities of a plurality of servers that are possible servers for executing a media processing task being executed in a first server that is one of the plurality of servers in a case where a media processing task executed in the first server is caused to transition to a second server different from the first server, and
the capabilities include presence or absence of a persistent storage capable of storing data of a task without depending on the task, and location information of the persistent storage.

An information processing method according to the second aspect of the present technology includes:
acquiring, by a task management unit of an information processing apparatus that manages a plurality of media processing tasks executed in one or a plurality of servers, capabilities of a plurality of servers that are possible servers for executing a media processing task being executed in a first server that is one of the plurality of servers in a case where a media processing task executed in the first server is caused to transition to a second server different from the first server; and
the capabilities include presence or absence of a persistent storage capable of storing data of a task without depending on the task, and location information of the persistent storage.

In the second aspect of the present technology, in the information processing apparatus that manages a plurality of media processing tasks executed in one or a plurality of servers, capabilities of a plurality of servers that are possible servers for executing a media processing task being executed in a first server that is one of the plurality of servers are acquired in a case where a media processing task executed in the first server is caused to transition to a second server different from the first server. The capabilities include presence or absence of a persistent storage capable of storing data of a task without depending on the task, and location information of the persistent storage.

Note that each of the processing system according to the first aspect and the information processing apparatus according to the second aspect of the present technology can be implemented by causing a computer to execute a program. The program executed by the computer can be provided by being transmitted via a transmission medium or by being recorded on a recording medium.

Each of the processing system and the information processing apparatus may be an independent device or an internal block constituting one device.

### BRIEF DESCRIPTION OF DRAWINGS

FIG. 1 is a block diagram illustrating a configuration example of a media processing system to which the technology of the present disclosure can be applied.

FIG. 2 is a block diagram of a control processing system of the present disclosure that performs control to cause media processing to transition between different edge servers.

FIG. 3 is a diagram describing task transition control processing by the control processing system in FIG. 2.

FIG. 4 is a flowchart of the task transition control processing.

FIG. 5 is a diagram describing details of a connectivity parameter.

FIG. 6 is a flowchart describing seamless processing continuation determination processing.

FIG. 7 is a diagram describing a data structure of a recovery object.

FIG. 8 is a diagram describing the data structure of the recovery object.

FIG. 9 is a block diagram illustrating a configuration example of hardware of a computer capable of achieving various embodiments of the present disclosure.

FIG. 10 is a block diagram of a computer and cloud computing capable of implementing various embodiments of the present disclosure.

### MODE FOR CARRYING OUT THE INVENTION

Hereinafter, modes for carrying out the technique of the present disclosure (hereinafter, referred to as embodiments) will be described with reference to the accompanying drawings. Note that, in this specification, the description of “and/or” means that both “and” and “or” can be taken. Furthermore, in this specification and the drawings, components having substantially the same functional configuration are denoted by the same reference numerals, and redundant explanations are omitted.

For definitions of terms and the like that are not directly defined in the detailed description of the invention of the present specification, the contents described in Non-Patent Documents 1 to 5 described above are cited by reference. For example, technical terms such as parsing, syntax, and semantics, and terms used in the File Structure described in Non-Patent Document 1 and the Interfaces for network media processing standard described in Non-Patent Document 2 are used similarly to the meanings used in Non-Patent Documents 1 to 5.

The description will be given in the following order.
1. Configuration example of media processing system
2. Configuration example of control processing system
3. Task transition control processing
4. Task transition control processing corresponding to network-based media processing
5. Seamless processing continuation determination processing
6. Data structure of recovery object
7. Configuration example of computer
8. Configuration example of cloud computing

<1. Configuration Example of Media Processing System>

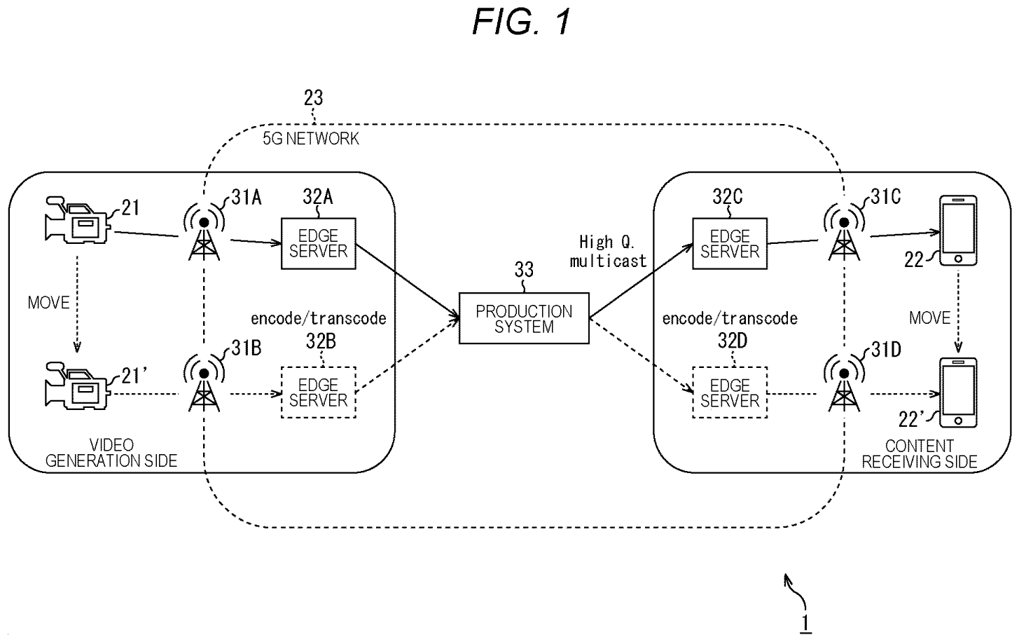

FIG. 1 is a block diagram illustrating a configuration example of a media processing system to which the technology of the present disclosure can be applied.

A media processing system 1 in FIG. 1 is a system that performs predetermined media processing on a video captured by a camera 21 as a video source and distributes the video to each terminal 22 that consumes content by utilizing a 5G network 23. The 5G network 23 includes a plurality of base stations 31 (31A to 31D), a plurality of edge servers 32 (32A to 32D), and a production system 33.

The camera 21 captures, for example, a video as content at an event venue such as sports, entertainment, or a live show. The video captured by the camera 21 is transmitted to the edge server 32A on the 5G network 23 via the base station 31A near the camera 21.

The edge server 32A performs predetermined media processing on a baseband video stream captured by the camera 21, and then transmits the baseband video stream to the production system 33. The media processing performed here is, for example, compression encoding of a baseband video stream, processing of enhancing a compressed encoded video stream from the camera 21, transcoding to another format, or the like.

The production system 33 includes one or a plurality of servers, performs switching, combining, and the like of videos captured by the plurality of cameras 21, and produces content to be distributed to each terminal 22. The production system 33 multicast-delivers a produced content video to each terminal 22 with high resolution. The content video transmitted from the production system 33 is transmitted to the edge server 32C on the 5G network 23, for example, and is distributed to the terminal 22 via the base station 31C. The edge server 32C and the base station 31C are arranged in the vicinity of the terminal 22.

The edge server 32C performs predetermined media processing on the content video transmitted from the production system 33, and then transmits the content video to the terminal 22 via the base station 31C. The media processing performed here is, for example, transcoding for individual optimization according to the performance or state of the terminal 22 or the state of the network.

The terminal 22 includes, for example, a smartphone, a tablet, a laptop computer, or the like, and displays the content video distributed via the base station 31C. The location of the terminal 22 can be moved as the viewing user moves.

In the media processing system 1 configured as described above, it is assumed that the optimal edge server 32 for performing each processing changes with movement of the camera 21 that is a video source and the terminal 22 consuming the content.

For example, in a case where the position of the camera 21 is moved to the position of a camera 21′ on the video generation side, the optimal edge server 32 is changed from the edge server 32A to the edge server 32B. In this case, it is necessary to cause the media processing such as compression encoding of the baseband video stream performed in the edge server 32A to transition to the edge server 32B.

Furthermore, for example, in a case where the position of the terminal 22 is moved to the position of the terminal 22′ on the content receiving side, the optimal edge server 32 is changed from the edge server 32C to the edge server 32D. In that case, it is necessary to cause the media processing such as transcoding of the content video to transition from the edge server 32C to the edge server 32D.

As a means for implementing the task transition between the cloud servers, it is conceivable to perform the task transition for each virtual machine or for each process on the virtual machine, but since the amount of data transfer increases, it takes a corresponding time and it is difficult to seamlessly continue the media processing. On the other hand, it is conceivable to reduce the data transfer amount by activating an equivalent process (media processing task) on the transition destination server in advance and transmitting only the internal state of the transition source task necessary for continuation of the media processing, but even in this case, data transfer between the servers is not always possible in a time necessary and sufficient for achieving seamless processing continuation.

As described above, in a case where it is necessary to cause the media processing being executed to transition between different edge servers, and the media processing needs continuity of processing for a certain period of time, consideration different from a case of general asynchronous processing is necessary.

<2. Configuration Example of Control Processing System>

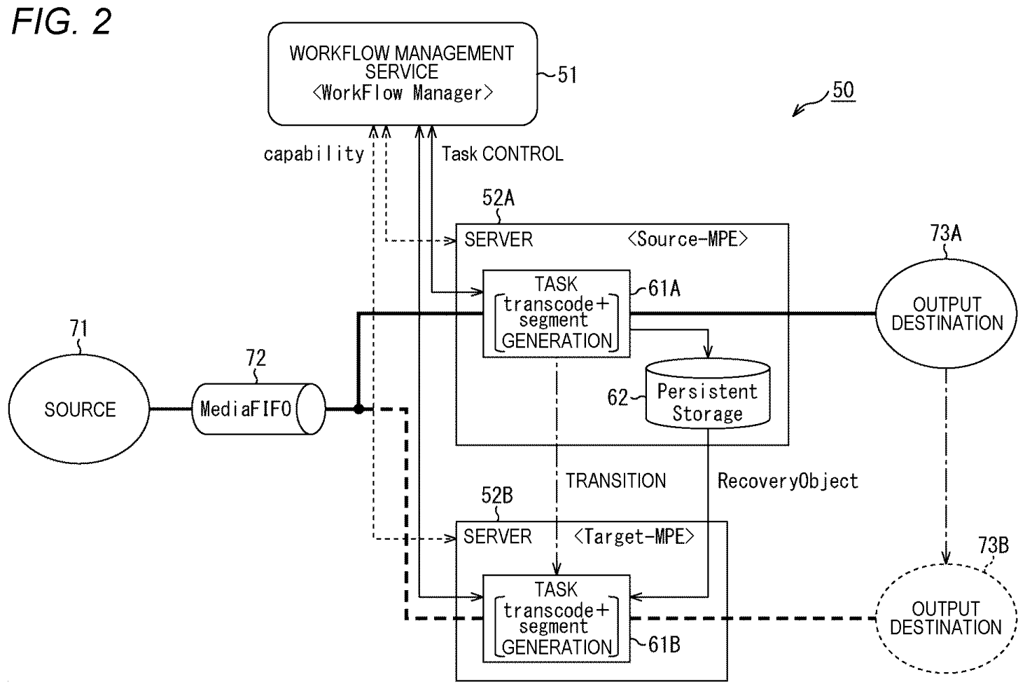

FIG. 2 is a block diagram of a control processing system of the present disclosure that performs control to cause media processing to transition between different edge servers.

A control processing system 50 of FIG. 2 includes a workflow management service 51 that manages media processing tasks and servers 52A and 52B. The workflow management service 51 is an application (program) executed on one or a plurality of servers, and manages a plurality of media processing tasks executed on one or a plurality of servers. For example, the workflow management service 51 performs task control to cause the media processing task being executed in the server 52A as the first server to transition to the server 52B as the second server.

A media processing task 61 transitioned between the server 52A and the server 52B performs, for example, transcoding and segment generation of content videos. A media processing task 61A executed on the server 52A transcodes a video stream as a source 71 acquired via a media FIFO 72, generates segments, and transmits the segments to an output destination 73A. After transitioning to the server 52B, a media processing task 61B executed on the server 52B transcodes the video stream, which is the source 71 obtained via the media FIFO 72, generates the segment, and transmits the segment to an output destination 73B. The output destinations 73A and 73B may be one and the same device, for example, a terminal or the like, or may be different devices, for example, edge servers or the like. The segment is data obtained by converting a video stream into a file every several seconds to about 10 seconds.

The workflow management service 51 determines the need for the task transition, and causes the media processing task 61A being executed in the server 52A to transition to the server 52B as necessary. Instead of the media processing task 61A of the server 52A, the media processing task 61B is activated and executed in the server 52B. The need for the task transition is determined on the basis of, for example, an event such as a change in the operating state of the server 52, a change in the network state, or a movement of the source 71 or the output destination 73.

In a case of causing transition of the media processing task 61A of the server 52A, the workflow management service 51 notifies the media processing task 61A of the storage location information of internal state information to be continuously executed by the media processing task 61B of the server 52B. In the example of FIG. 2, state recovery information is stored in a persistent storage 62 included in the server 52A, and the workflow management service 51 notifies the persistent storage 62 of the server 52A as the storage location information of the internal state information. The persistent storage 62 is a storage unit capable of storing data of the media processing task 61 without depending on the execution state of the media processing task 61 such as activation and disappearance of a task, and includes a hard disk, a solid state drive (SSD), an erasable and programmable read only memory (EPROM), or the like. The internal state information stored in the persistent storage 62 is information necessary for recovering a state of temporarily interrupted processing, and is hereinafter also referred to as state recovery information, and is also referred to as a recovery object in the framework of the network-based media processing (NBMP) disclosed in Non-Patent Document 3. The media processing task 61A of the server 52A stores the state recovery information in the persistent storage 62 of the server 52A. Note that the persistent storage 62 in which the media processing task 61A of the server 52A stores the state recovery information may be the persistent storage 62 on the server 52 different from the server 52A that is executing the task.

The media processing task 61B executed on the server 52B acquires the state recovery information from the persistent storage 62. Then, the media processing task 61B then uses the state recovery information to perform the same tasks as the media processing task 61A.

The workflow management service 51 acquires a capability from each server 52, determines the need for the task transition, and selects the persistent storage 62 that stores the state recovery information.

The capability is information indicating the performance and function of the server 52 itself, and for example, the following information (parameters) can be acquired as the capability.
resource-availabilities: indicates the availability of resources of the server 52.

Example: {“vcpu”, 4, 30}: there are four vcpu, and 30% of them is available.
placement: geographic location of the server 52
location: location on the network of the server 52 (URL, IP address, or the like)
functions: a list (array) of Function Description of functions executable by the server 52
connectivity: connection performance with another server 52
persistency-capability: whether or not the storage unit provided by the server 52 is persistent (held without depending on the state of the task) (true/false)
secure-persistency: whether or not the data transfer of the persistent storage is secure (true/false)
persistence-storage-url: location of persistent storage (URL)

The control processing system 50 of FIG. 2 can be incorporated and operated in the media processing system 1 of FIG. 1. In this case, the workflow management service 51 corresponds to a part of the production system 33. The server 52A corresponds to, for example, the edge server 32A, the edge server 32C, and the like, and the server 52B corresponds to, for example, the edge server 32B, the edge server 32D, and the like.

Hereinafter, the server 52A before the media processing task 61 transitions may be referred to as a transition source server 52A, and the server 52B after the transition may be referred to as a transition destination server 52B. In the framework of the network-based media processing (NBMP) disclosed in Non-Patent Document 3, the workflow management service 51 corresponds to the WorkFlow Manager, which is a task management unit that manages tasks, and the server 52 corresponds to a media processing entity (MPE). For the MPE, when the transition source server 52A and the transition destination server 52B are distinguished, the transition source server 52A can be referred to as Sorce-MPE, and the transition destination server 52B can be referred to as Target-MPE.

<3. Task Transition Control Processing>

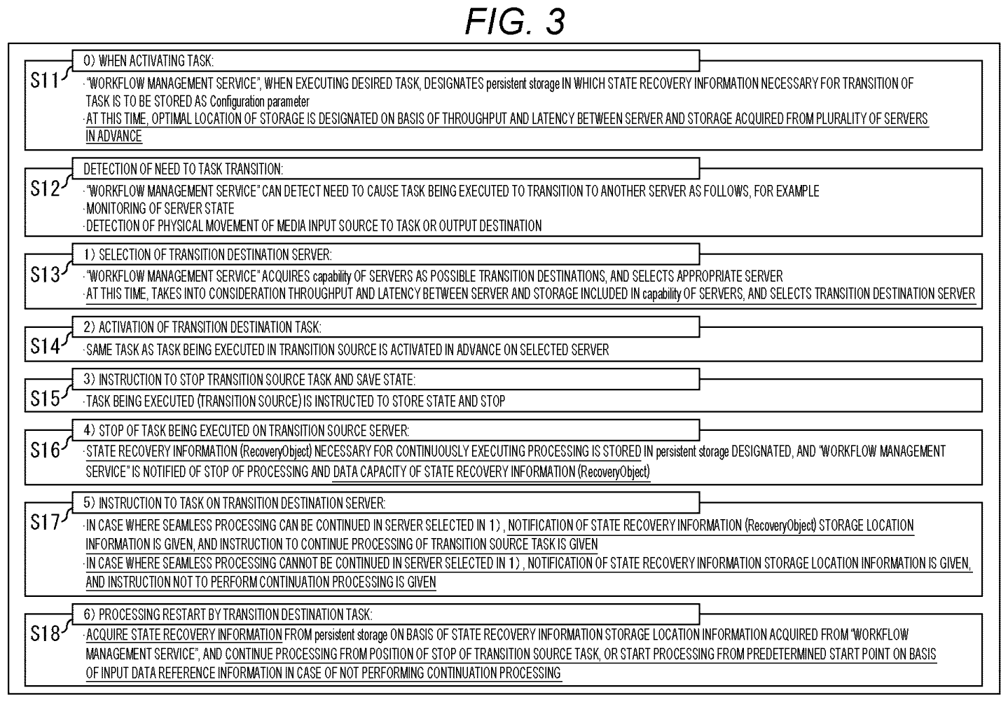

Task transition control processing by the control processing system 50 will be described with reference to FIG. 3.

First, in step S11, the workflow management service 51 causes the server 52A to execute a media processing task 61A, which is a desired task. At that time, the workflow management service 51 designates the persistent storage 62 in which the state recovery information necessary for transition of the task is to be stored as a configuration parameter. The workflow management service 51 designates an optimal location of the persistent storage 62 on the basis of capability information acquired from a plurality of servers 52 in advance, for example, throughput and latency between the server and the storage.

In step S12, the workflow management service 51 detects the need to cause the media processing task 61A being executed to transition to another server 52. The workflow management service 51 can detect the need for the task transition on the basis of, for example, a monitoring result of the state of the server 52, detection of physical movement of the source 71 (media input source) to the media processing task 61 or the output destination 73A.

In step S13, the workflow management service 51 acquires the capabilities of the plurality of servers 52 as possible transition destinations, and selects an appropriate server 52 on the basis of the acquired capabilities of the possible transition destinations. The selection of an appropriate server 52 takes into consideration the throughput and latency between the server and the storage included in the capability of the server 52. In the present embodiment, the server 52B is selected as the appropriate server 52.

In step S14, the workflow management service 51 activates the same task as the media processing task 61A being executed in the transition source in advance on the selected server 52B. Thus, the media processing task 61B is activated on the server 52B.

In step S15, the workflow management service 51 instructs the media processing task 61A being executed (transition source) to store the state and stop.

In step S16, the media processing task 61A of the server 52A stores the state recovery information (recovery object) necessary for continuously executing the processing in the persistent storage 62 designated in step S11, and notifies the workflow management service 51 of the stop of the processing and the data capacity of the state recovery information.

In step S17, the workflow management service 51 determines whether or not seamless processing continuation is possible in the transition destination server 52B on the basis of the throughput, the latency, and the like between the persistent storage 62 in which the state recovery information is stored and the transition destination server 52B. In a case where it is determined that the seamless processing continuation is possible, the workflow management service 51 gives a notification of the state recovery information storage location information indicating the storage location of the state recovery information, that is, the location of the persistent storage 62, and gives an instruction to continue the processing. On the other hand, in a case where it is determined that the seamless processing continuation is not possible, the workflow management service 51 gives a notification of the state recovery information storage location information, and gives an instruction not to perform the continuation processing.

In step S18, the media processing task 61B of the transition destination server 52B acquires the state recovery information from the persistent storage 62 on the basis of the state recovery information storage location information acquired from the workflow management service 51. Then, in a case where an instruction to continue the processing is given from the workflow management service 51, the media processing task 61B continues the processing from the position of stop of the processing of the media processing task 61A of the transition source server 52A. On the other hand, in a case where an instruction not to continue the processing is given from the workflow management service 51, the media processing task 61B starts the processing from a predetermined start point on the basis of the reference information of the input data.

As described above, the workflow management service 51 acquires the capabilities of the plurality of servers 52 as the possible transition destinations, and acquires in advance the data transfer speed (throughput) and the delay time (latency) between each of the servers 52 as the possible transition destinations and the persistent storage 62 in which the state recovery information is stored. Then, in view of the data capacity of the state recovery information a notification of which is given from the media processing task 61A being executed on the transition source server 52A, the workflow management service 51 instructs the transition destination server 52B to seamlessly continue the processing from the position of stop of the processing of the media processing task 61A of the transition source server 52A or to start the processing from an alternative start point without continuing the processing.

<4. Task Transition Control Processing Corresponding to Network-Based Media Processing>

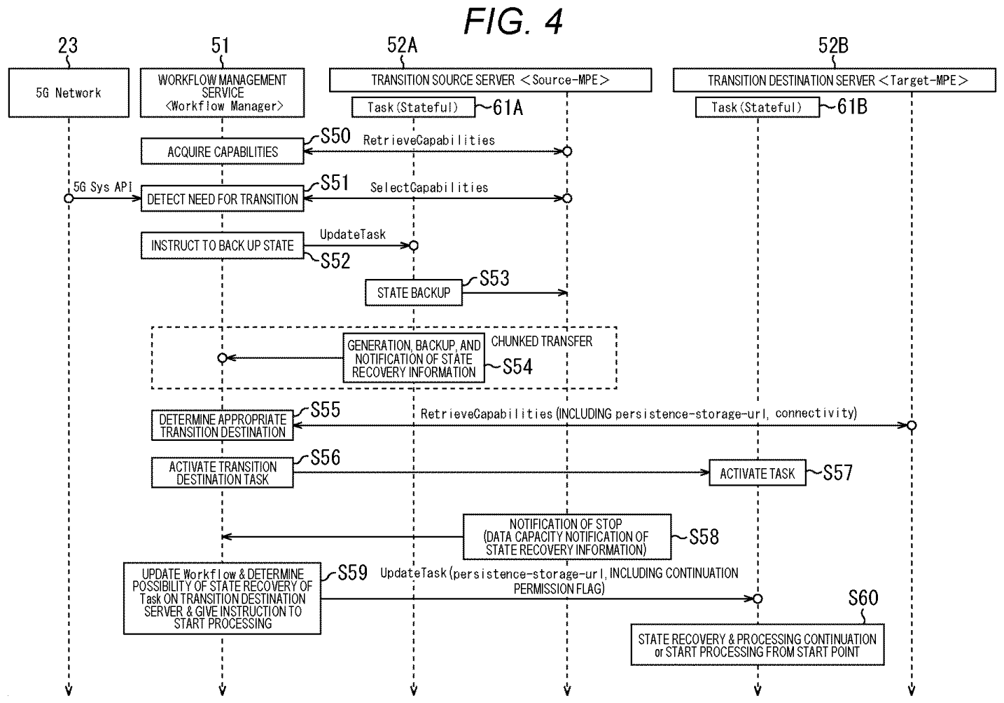

Next, task transition control processing corresponding to the network-based media processing (hereinafter referred to as NBMP) disclosed in Non-Patent Document 3 will be described with reference to a flowchart of FIG. 4.

In the flowchart of FIG. 4, processing of determining the need for task transition of the media processing task 61A being executed on the transition source server 52A will be described. Before the media processing task 61A is executed, as illustrated as step S50, the workflow management service 51 acquires the capability of each server 52 and then activates and executes the media processing task 61A on the transition source server 52A.

In the NBMP, the workflow management service 51 which is the WorkFlow Manager can acquire the capability of each server 52 by issuing HTTP GET RetrieveCapabilities with an MPE Capabilities Description Document attached to a request body to each server 52 which is an MPE.

RetrieveCapabilities is an MPE API, and the MPE Capabilities Description includes respective Descriptors of General, Capabilities, and Events. The id of the General Descriptor in the MPE Capabilities Description is matched with the id of the server 52 that is the MPE from which the capability is to be acquired. In a case where HTTP GET RetrieveCapabilities is successful, an MPE Capabilities Description Document in which actual capabilities are described in a Capabilities descriptor is returned as a response. Specific parameters of the Capabilities descriptor are the above-described resource-availabilities, placement, location functions, connectivity, persistency-capability, secure-persistency, and persistence-storage-url. General Descriptor and Events Descriptor are defined in ISO/IEC 23090-8: 2020.

In step S51, the workflow management service 51 determines the need for the task transition on the basis of an event such as a change in the network state of the 5G network 23, a change in the operating state of the transition source server 52A, or a movement of the source 71 or the output destination 73. In a case where it is detected in step S51 that task transition is necessary, the workflow management service 51 issues HTTP POST SelectCapabilities with an MPE Capabilities Description Document attached to the request body to the control unit of the transition source server 52A, thereby securing a storage (backup storage) for storing state recovery information on the transition source server 52A. Thus, the persistent storage 62 on the transition source server 52A is secured. A URL (RecoveryObjectURLs) indicating the location of the persistent storage 62 is stored in persistence-storage-url which is a parameter in MPE Capabilities Description of SelectCapabilities. SelectCapabilities is an MPE API that designates use of a specific capability from among capabilities acquired by RetrieveCapabilities, and a URL (persistence-storage-url) of the persistent storage 62 on the transition source server 52A is designated. In a case where HTTP POST SelectCapabilities is successful, an MPE Capabilities Description Document reflecting the parameters as designated is returned as a response.

Subsequently, in step S52, the workflow management service 51 issues an HTTP PATCH UpdateTask with a Task Description Document attached to the request body to the media processing task 61A of the transition source server 52A, thereby giving an instruction to back up (store) the state recovery information in the persistent storage 62 and stop the task (process). In the Task Description, a URL (RecoveryObjectURLs) indicating a storage location of the state recovery information, that is, a location of the persistent storage 62 may be designated, or in a case where the media processing task 61A knows the storage location because the persistent storage 62 is in the same server, the designation of the storage location may be omitted.

In step S53, the media processing task 61A of the transition source server 52A stores the state recovery information in the persistent storage 62 in the same server on the basis of a backup instruction of the state recovery information from the workflow management service 51.

As a response to the UpdateTask of the Task API transmitted by the workflow management service 51 to the media processing task 61A in step S52, the control unit of the transition source server 52A gives a notification of the stop of the task and the data capacity of the state recovery information (recovery object) in step S58 to be described later.

Alternatively, as a response to the UpdateTask of the Task API, the media processing task 61A may give a notification of generation and backup of the state recovery information at every moment by chunked transfer as step S54. In this case, in a URL (RecoveryObjectURLs) indicating the location of the persistent storage 62 included in Task Description, the update amount of the state recovery information is enumerated endlessly until the stop of the task is detected or the chunked transfer is forcibly stopped.

In step S55, the workflow management service 51 acquires the capabilities of the plurality of servers 52 as possible transition destinations, and selects (determines) an appropriate transition destination. Specifically, the workflow management service 51 acquires the capability of each server 52 by issuing HTTP GET RetrieveCapabilities with an MPE Capabilities Description Document attached to a request body to a plurality of servers 52 as possible transition destinations.

As described above, the Capabilities descriptor of RetrieveCapabilities, which is an MPE API, includes parameters of persistence-storage-url and connectivity. The persistence-storage-url parameter is a URL of a persistent storage in a case where there is a persistent storage, and the connectivity parameter is connection performance with another server 52 that is a data transfer partner.

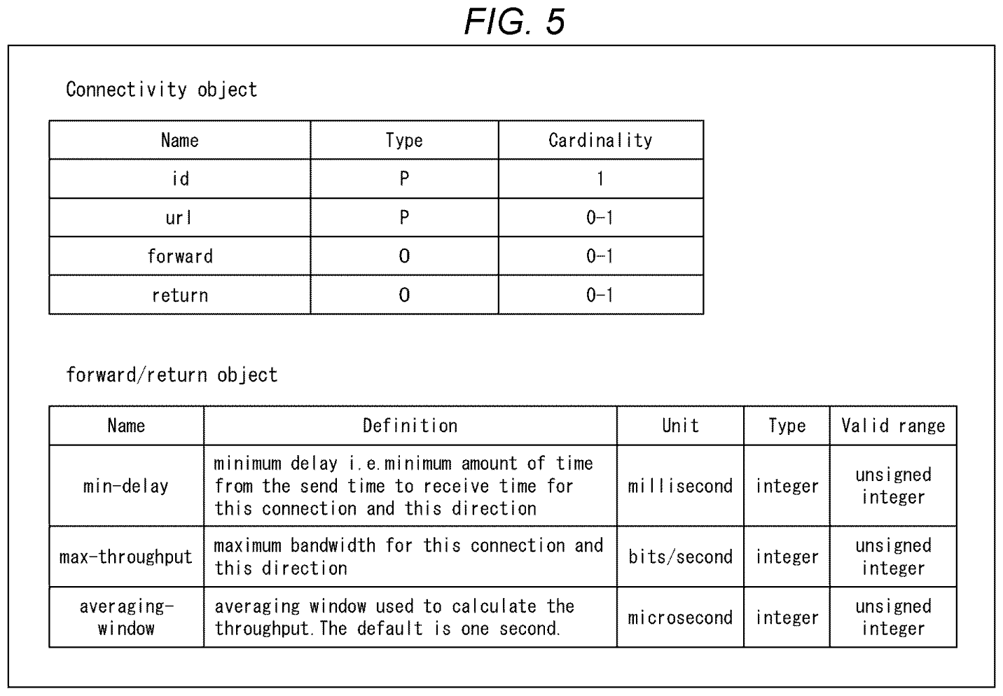

FIG. 5 is a diagram illustrating details of the connectivity parameter.

The table in the upper part of FIG. 5 illustrates details of the connectivity object indicating a specific configuration example of the connectivity parameter.

The connectivity object has items of id, url, forward, and return. For the data type (Type), “P” represents a parameter, and “0” represents an object. As for Cardinality, “1” indicates that the item is essential, and “0-1” indicates that the item may or may not be present, and in a case where the item is present, the number of items is limited to one.

Therefore, the data type of the item id and url is a parameter, and the data type of the item forward and return is an object. The item id is essential, but the item url, forward, and return may or may not be present (optional).

The item id represents an id of the target server 52 that is a data transfer partner.

The item url indicates a uniform resource locator (URL) of the target server 52.

The item forward represents a capability of data transfer toward the target.

The item return represents the capability of data transfer from the target.

The lower table in FIG. 5 illustrates details of the forward and return objects indicating specific configuration examples of the items forward and return.

Each of the forward and return objects has items of min-delay, max-throughput, and averaging-window.

min-delay represents a minimum delay time of data transfer. The unit is millisecond.

max-throughput represents a maximum rate of data transfer. The unit is bits per second (bits per second).

averaging-window represents the length of an averaging window when the maximum speed of data transfer is calculated. The unit is microsecond.

In step S55, the workflow management service 51 acquires the MPE Capabilities Description Document for the plurality of servers 52 as possible transition destinations, and acquires connection performance with another server 52 indicated by the connectivity parameter included in the MPE Capabilities Description Document. Then, the workflow management service 51 selects an appropriate transition destination on the basis of the acquired connectivity parameter. Here, the transition destination server 52B is selected as an appropriate transition destination.

In step S56, the workflow management service 51 activates the media processing task 61B on the selected transition destination server 52B. Thus, in step S57, the media processing task 61B is activated on the transition destination server 52B.

Either processing may be executed first, or the processing can be executed in parallel in the instruction to back up the state recovery information and stop the task in step S52 described above and the selection of the appropriate transition destination and the task activation in steps S55 and S56 described above. In other words, while the transition source server 52A stores the state recovery information in the persistent storage 62, the media processing task 61B is activated in advance on the transition destination server 52B.

When the saving of the state recovery information in the persistent storage 62 by the transition source server 52A is completed and the task is stopped, the control unit of the transition source server 52A notifies the workflow management service 51 of the stop of the task as a response to the UpdateTask of the Task API in step S58. Furthermore, in addition to the task stop, the workflow management service 51 is also notified of the storage location (URL) of the state recovery information (recovery object) and the data capacity of the state recovery information. The data capacity of the state recovery information is described in byte units.

The task stop and the notification of the storage location and the data capacity of the state recovery information in step S58 may be performed as a response to the UpdateTask of the Task API as described above, or may be performed as a response to SelectCapabilities of the MPE API in step S51.

In a case where the notification is performed as a response to SelectCapabilities of the MPE API, the workflow management service 51 can designate to give a notification of the data capacity of the state recovery information at the end of the task using, for example, an Events Descriptor included in MPE Capabilities Description. Specifically, the Events object has respective parameters of a name, a definition, and a url of an event as specified in ISO/IEC 23090-8: 2020. The workflow management service 51 stores the task that has performed the backup processing of the state recovery information, that is, the task id of the media processing task 61A in the name of the event, stores the data capacity of the state recovery information stored in the persistent storage 62 by the media processing task 61A in the definition, and designates the url so that the URL indicating the notification destination of the data capacity designated by the workflow management service 51 is stored in the url. The notification destination of the data capacity indicated by the URL may be the workflow management service 51 or the transition source server 52A that acquires the state recovery information.

Upon acquiring the notification of a task stop and the storage location and data capacity of the state recovery information from the transition source server 52A, the workflow management service 51 updates the workflow in step S59. Specifically, the workflow management service 51 changes the workflow so that the video stream output from the source 71 is transferred to the transition destination server 52B. Furthermore, in step S59, the workflow management service 51 determines whether the state can be recovered in the media processing task 61B of the transition destination server 52B in consideration of the data capacity of the state recovery information stored in the persistent storage 62 and the data transfer speed between the persistent storage 62 and the transition destination server 52B. A notification of the data capacity of the state recovery information is given together with the task stop in step S58, and the data transfer speed between the persistent storage 62 and the transition destination server 52B can be recognized from the connectivity parameter of the transition destination server 52B.

The workflow management service 51 determines whether or not state recovery can be performed, that is, whether or not the media processing task 61B can recover the state of the media processing task 61A and seamlessly continue the processing, and instructs the media processing task 61B of the transition destination server 52B to start the processing. Specifically, the workflow management service 51 issues an HTTP PATCH UpdateTask with a Task Description Document attached to the request body to the media processing task 61B of the transition destination server 52B, thereby instructing to start the processing. At that time, the workflow management service 51 includes the URL (persistence-storage-url) of the persistent storage 62, which is the state recovery information storage location information, and a continuation possibility flag in the UpdateTask as parameters of the UpdateTask that is the Task API. In a case where it is determined that the processing can be seamlessly continued, the workflow management service 51 sets, for example, “1” representing the continuation processing to the continuation possibility flag, and in a case where it is determined that the processing cannot be seamlessly continued, the workflow management service 51 sets “0” representing the non-continuation processing of starting the processing from a predetermined start point.

In step S60, the media processing task 61B of the transition destination server 52B acquires the UpdateTask from the workflow management service 51 and starts the processing. Specifically, in a case where the continuation possibility flag of the UpdateTask indicates continuation processing, the media processing task 61B acquires the state recovery information of the persistent storage 62, recovers the state, and then seamlessly starts the processing from the interruption point of the media processing task 61A. On the other hand, in a case where the continuation possibility flag of the UpdateTask indicates non-continuation processing, the media processing task 61B acquires the state recovery information of the persistent storage 62 and starts the processing from a predetermined start point.

The task transition control processing corresponding to the network-based media processing can be executed as described above. By the task transition control processing by the control processing system 50, a media processing task that needs continuity of processing can be caused to transition between the servers of the transition source server 52A and the transition destination server 52B.

<5. Seamless Processing Continuation Determination Processing>

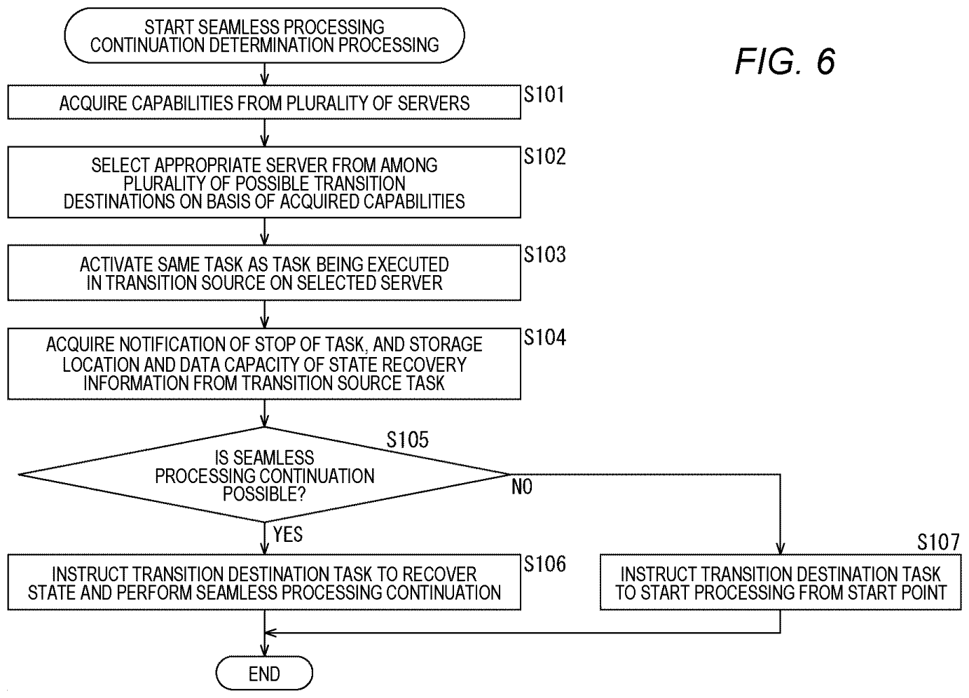

Next, details of seamless processing continuation determination processing performed by the workflow management service 51 will be described with reference to the flowchart of FIG. 6. This processing corresponds to the processing of steps S55 to S59 of the workflow management service 51 in the task transition control processing of FIG. 4.

In step S101, the workflow management service 51 acquires the capabilities from the plurality of servers 52 that are possible transition destinations. The one or more servers 52 to be possible transition destinations correspond to, for example, an edge server near the source 71, an edge server near the output destination 73, and the like.

In step S102, the workflow management service 51 selects (determines) an appropriate server 52 from among the plurality of servers 52 of possible transition destinations on the basis of the acquired capabilities.

In step S103, the workflow management service 51 activates the same task as the media processing task 61A being executed in the transition source server 52A on the selected server 52. The task activated by the transition destination server 52B is the media processing task 61B.

In step S104, the workflow management service 51 acquires a notification of the stop of the task, and the storage location and the data capacity of the state recovery information from the control unit of the transition source server 52A or the media processing task 61A.

Upon acquiring the task stop and the notification of the storage location and data capacity of the state recovery information, the workflow management service 51 determines in step S105 whether or not seamless processing continuation is possible in the media processing task 61B of the transition destination server 52B. On the basis of the data capacity of the state recovery information and the data transfer speed (throughput) and the delay time (latency) between the persistent storage 62 and the transition destination server 52B recognized from the connectivity parameter of the transition destination server 52B, it is determined whether seamless processing continuation is possible.

In a case where it is determined in step S105 that the seamless processing continuation is possible, the processing proceeds to step S106, and the workflow management service 51 instructs the media processing task 61B of the transition destination server 52B to recover the state and perform the seamless processing continuation.

On the other hand, in a case where it is determined in step S105 that the seamless processing continuation is not possible, the processing proceeds to step S107, and the workflow management service 51 instructs the media processing task 61B of the transition destination server 52B to start the processing from the alternative start point.

As described above, the seamless processing continuation determination processing by the workflow management service 51 ends, and the media processing task 61B of the transition destination server 52B can start seamless processing continuation or start the processing from a predetermined start point after performing state recovery based on the state recovery information stored in the persistent storage 62. Thus, the media processing task that needs continuity of processing can be caused to transition between the servers of the transition source server 52A and the transition destination server 52B.

<6. Data Structure of Recovery Object>

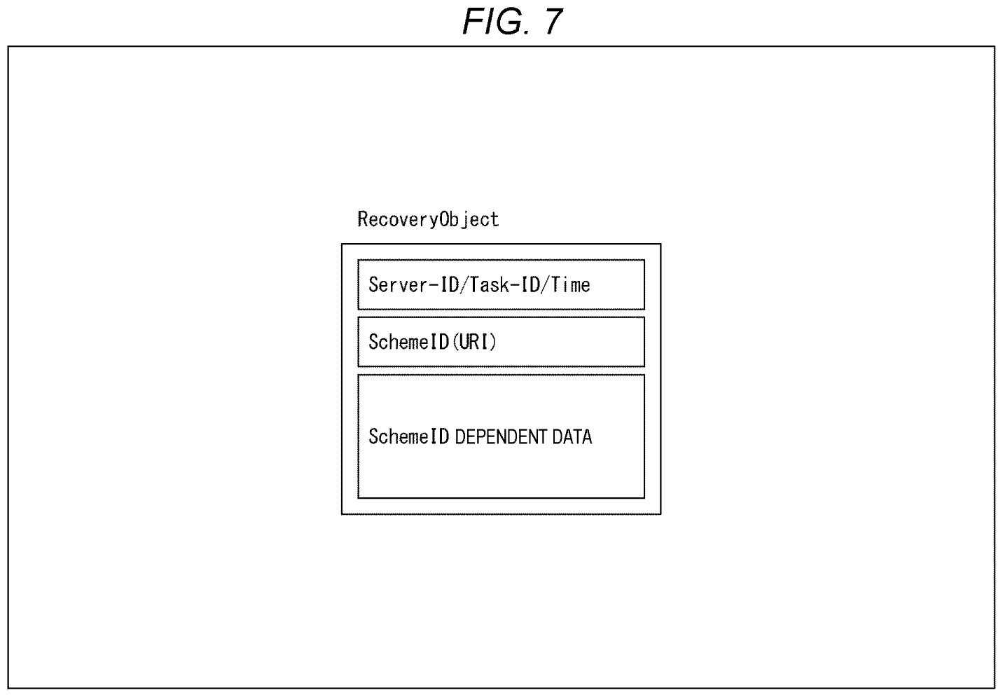

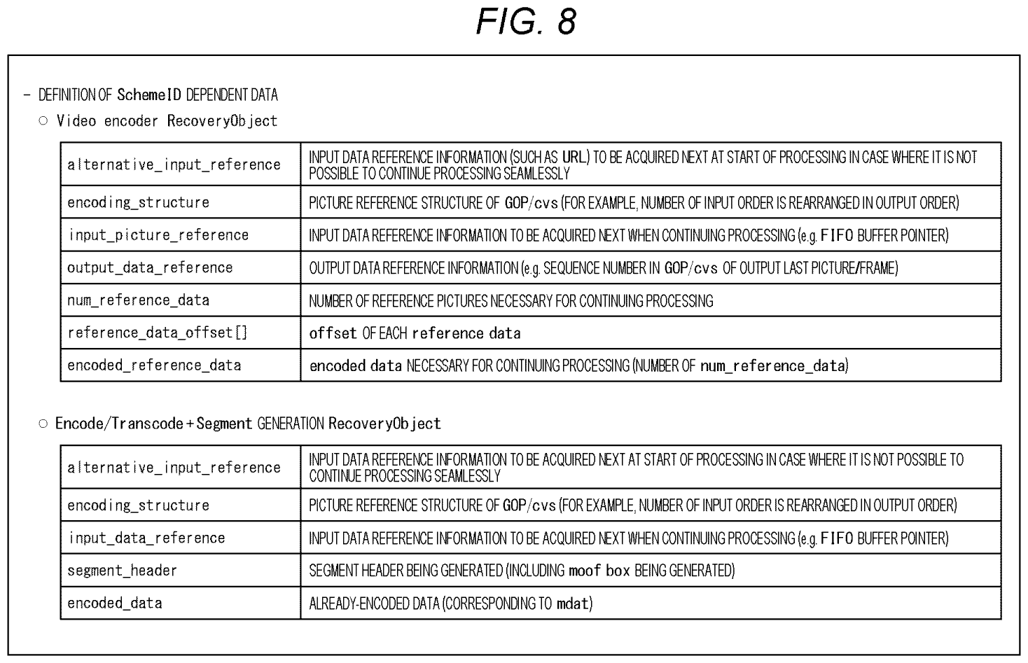

The data structure of the recovery object in which the state recovery information is stored will be described with reference to FIGS. 7 and 8.

FIG. 7 is a diagram illustrating a data structure of the recovery object.

The recovery object has the following data 1) to 3).
1) Server ID/task ID/time information
2) Scheme ID
3) Scheme ID dependent data

The server ID stores an id uniquely assigned to the server 52. In the task ID, an id uniquely assigned to the media processing task is stored. In the time information, for example, time information defined by Coordinated Universal Time (UTC) or local time (LT) which is the time of the standard time of each time zone is stored.

A character string (Uniform Resource Identifier (URI)) indicating the type of the media processing task is stored in the scheme ID. For example, nbmp-brand (urn) of the NBMP reference function can be stored as the scheme ID.

The scheme ID dependent data stores data dependent on the scheme ID, in other words, different data for each content of the media processing task.

FIG. 8 illustrates examples of scheme ID dependent data in a case where the media processing task indicated by the scheme ID is video encoding processing, and in a case where the media processing task is video encoding/transcoding processing and segment generation processing of video.

In a case where the media processing task indicated by the scheme ID is video encoding processing, the following data is stored in the recovery object as scheme ID dependent data.
alternative_input_reference: reference information of input data to be acquired next at the start of processing in a case where processing cannot be continued seamlessly
encoding_structure: a picture reference structure of group of picture (GOP)/coded video sequence (cvs) at the time of encoding (for example, the number of the input order is rearranged in the output order)
input_picture_reference: reference information (for example, pointer information for a FIFO buffer, such as the media FIFO 72) of input data to be acquired next at a time of continuing processing
output_data_reference: reference information of the output data (for example, the sequence number in GOP/cvs of the output last picture/frame)
num_reference_data Number of reference pictures necessary for continuing processing
reference_data_offset[ ]: offset of each reference picture
encoded_reference_data: data of each reference picture necessary for continuing the processing (the number of reference pictures)

The data of each reference picture is indicated by a byte offset value from the head of the entire picture data.

In a case where the media processing task indicated by the scheme ID includes segment generation processing, the following data is stored in the recovery object as scheme ID dependent data.
alternative_input_reference: reference information of input data to be acquired next at the start of processing in a case where processing cannot be continued seamlessly
encoding_structure: a picture reference structure of GOP (group of picture)/cvs (coded video sequence) of the segment (for example, the number of the input order is rearranged in the output order).
input_data_reference: reference information (for example, pointer information for a FIFO buffer, such as the media FIFO 72) of input data to be acquired next at a time of continuing processing
segment_header: segment header being generated (including moof box (Movie Fragment Box) of MP4)
encoded_data: already-encoded data (the number of generated samples and sample data in a segment corresponding to mdat (Media Data Box))

The segment_header and the encoded_data correspond to processed data in the segment.

<7. Configuration Example of Computer>

A series of processes performed by the workflow management service 51 or the server 52 described above can be executed by hardware or software. In a case where a series of processing is executed by the software, a program which forms the software is installed on a computer. Here, the computer includes a microcomputer incorporated in dedicated hardware, a general-purpose personal computer capable of executing various functions by installing various programs, and the like, for example.

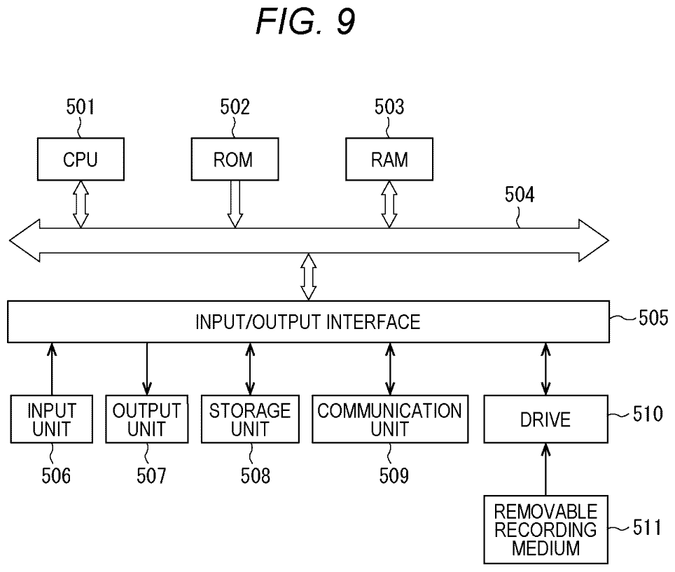

FIG. 9 is a block diagram illustrating a configuration example of hardware of a computer as an information processing apparatus that executes the above-described series of processing by a program.

In the computer, a central processing unit (CPU) 501, a read only memory (ROM) 502, and a random access memory (RAM) 503 are mutually connected by a bus 504.

An input/output interface 505 is further connected to the bus 504. An input unit 506, an output unit 507, a storage unit 508, a communication unit 509, and a drive 510 are connected to the input/output interface 505.

The input unit 506 includes a keyboard, a mouse, a microphone, a touch panel, an input terminal, and the like. The output unit 507 includes a display, a speaker, an output terminal, and the like. The storage unit 508 includes a hard disk, a RAM disk, a nonvolatile memory, and the like. The communication unit 509 includes a network interface or the like. The drive 510 drives a removable recording medium 511 such as a magnetic disk, an optical disk, a magneto-optical disk, or a semiconductor memory.

In the computer configured as described above, for example, the CPU 501 loads the program stored in the storage unit 508 into the RAM 503 via the input/output interface 505 and the bus 504 and executes the program, to thereby perform the above-described series of processing. The RAM 503 also appropriately stores data necessary for the CPU 501 to execute various processes, for example.

A program executed by the computer (CPU 501) can be provided by being recorded on the removable recording medium 511 as a package medium, or the like, for example. Furthermore, the program can be provided via a wired or wireless transmission medium such as a local area network, the Internet, or digital satellite broadcasting.

In the computer, by attaching the removable recording medium 511 to the drive 510, the program can be installed in the storage unit 508 via the input/output interface 505. Furthermore, the program can be received by the communication unit 509 via a wired or wireless transmission medium, and installed in the storage unit 508. In addition, the program can be installed in the ROM 502 or the storage unit 508 in advance.

<8. Configuration Example of Cloud Computing>

The methods and systems described in this specification, including the media processing system 1 and the control processing system 50 described above and methods for processing information thereby, can be implemented using computer programming or engineering techniques, including computer software, firmware, hardware, or a combination or subset thereof.

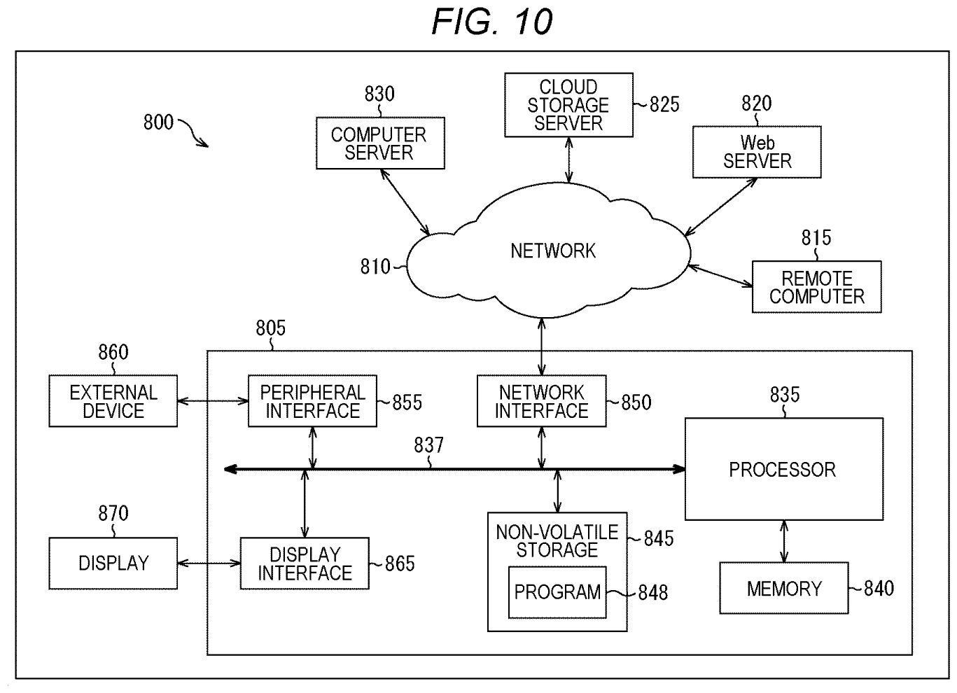

FIG. 10 illustrates a block diagram of a computer and cloud computing capable of implementing various embodiments described herein.

The present disclosure can be implemented as a system, a method, and/or a computer program. The computer program may include a computer-readable storage medium, and computer-readable program instructions that cause one or more processors to execute aspects of the embodiments are recorded on the computer-readable storage medium.

The computer-readable storage medium can be a tangible device that can store instructions for use in an instruction execution device (a processor). The computer-readable storage medium may be, for example, but not limited to, an electronic storage device, a magnetic storage device, an optical storage device, an electromagnetic storage device, a semiconductor storage device, or any suitable combination of those devices. More specific examples of the computer-readable storage medium include each (and suitable combinations) of the following: a flexible disk, a hard disk, a solid state drive (SSD), a random access memory (RAM), a read only memory (ROM), an erasable and programmable read only memory (EPROM) or a flash memory (Flash), a static random access memory (SRAM), a compact disk (CD or CD-ROM), a digital versatile disc (DVD), and a card type or a stick type memory. The computer-readable storage medium as used in the present disclosure is not to be construed as being a transitory signal itself, such as a radio wave or other freely propagating electromagnetic wave, an electromagnetic wave propagating through a waveguide or other transmission medium (for example, a light pulse through an optical fiber cable), or an electrical signal sent over a wire.

Computer-readable program instructions of the present disclosure may be downloaded from the computer-readable storage medium to a suitable computing or processing device, or may be downloaded to an external computer or external storage, for example, via a global network such as the Internet, a local area network, a wide area network, and/or a wireless network. The network includes a copper transmission line, an optical communication fiber, wireless transmission, a router, a firewall, a switch, a gateway computer, an edge server, and/or the like. A network adapter card or a network interface in a computing device or a processing device can receive the computer-readable program instructions from the network, and transfer and store the computer-readable program instructions on the computer-readable storage medium in the computing device or the processing device.

The computer-readable program instructions for executing the processes of the present disclosure include machine language instructions and/or microcode, and these are compiled or interpreted from source code written in any combination of one or more program languages, including an assembly language, Basic, Fortran, Java (registered trademark), Python, R, C, C++, C#, or similar programming languages. The computer-readable program instructions can be executed completely on a user's personal computer, laptop computer, tablet, or smartphone, and can also be executed completely on a remote computer or computer server, or any combination of these computing devices. The remote computer or computer server may be connected to a user's device or a device via a computer network, such as a local area network, a wide area network, or a global network (for example, the Internet). In order to implement aspects of the present disclosure, there is also an embodiment in which, for example, an electric circuit including a programmable logic circuit, a field-programmable gate array (FPGA), and a programmable logic array (PLA) uses information from computer-readable program instructions for configuring or customizing the electronic circuit, and execute the computer-readable program instructions.

Aspects of the present disclosure are described in this specification with reference to flowcharts and block diagrams of a method, a device (a system), and a computer program according to an embodiment of the disclosure. It will be understood by those skilled in the art that each block of the flowcharts and the block diagrams, and combinations of blocks in the flowcharts and the block diagrams can be implemented by computer-readable program instructions.

The computer-readable program instructions capable of executing the system and the method described in the present disclosure are used by one or more processors (and/or one or more cores in the processor) of a general purpose computer, a special purpose computer, or other programmable devices for manufacturing a device. By executing program instructions via a processor of a computer or other programmable devices, a system for implementing functions described in the flowcharts and the block diagrams of the present disclosure is created. These computer-readable program instructions may also be stored in a computer-readable storage medium that can instruct a computer, a programmable device, and/or other devices to function in a specific method. Accordingly, the computer-readable storage medium storing instructions is an article of manufacture including instructions for implementing aspects of the functions specified in the flowcharts and the block diagrams of the present disclosure.

The computer-readable program instructions are loaded onto a computer, other programmable device, or other device, and execute a series of operational steps on the computer, other programmable device, or other device, to generate a processing result of the computer.

By the program instructions being executed on the computer, other programmable device, or other device, functions specified in the flowcharts and the block diagrams of the present disclosure are implemented.

FIG. 10 is a functional block diagram of a network system 800 in which one or a plurality of computers, servers, and the like are connected via a network. It should be noted that hardware and software environments shown in an embodiment of FIG. 10 is shown as an example of providing a platform for implementing software and/or a method according to the present disclosure.

As illustrated in FIG. 10, the network system 800 may include, but is not limited to, a computer 805, a network 810, a remote computer 815, a web server 820, a cloud storage server 825, and a computer server 830. In one embodiment, multiple instances of one or more functional blocks illustrated in FIG. 10 are used.

FIG. 10 illustrates a more detailed configuration of the computer 805. Note that the functional blocks illustrated in the computer 805 are illustrated to establish exemplary functions and not all illustrated. Furthermore, although detailed configurations of the remote computer 815, the web server 820, the cloud storage server 825, and the computer server 830 are not illustrated, they may include configurations similar to the functional blocks illustrated for the computer 805.

As the computer 805, it is possible to use a personal computer (PC), a desktop computer, a laptop computer, a tablet computer, a netbook computer, a personal digital assistant (PDA), a smartphone, or any other programmable electronic device capable of communicating with other devices on the network 810.

Then, the computer 805 includes a processor 835, a bus 837, a memory 840, a non-volatile storage 845, a network interface 850, a peripheral interface 855, and a display interface 865. Each of these functions may be implemented as an individual electronic subsystem (an integrated circuit chip or a combination of a chip and an associated device) in one embodiment, and some functions may be combined and implemented as a single chip (system on chip or SoC) in another embodiment.

The processor 835 can be one or more single or multi-chip microprocessors, such as, for example, one designed and/or manufactured by Intel Corporation, Advanced Micro Devices, Inc. (AMD), Arm Holdings (Arm), or Apple Computer. Examples of the microprocessor include Celeron, Pentium (registered trademark), Core i3, Core i5, and Core i7 manufactured by Intel Corporation, Opteron, Phenom, Athlon, Turion, and Ryzen manufactured by AMD, and Cortex-A, Cortex-R, and Cortex-M manufactured by Arm.

The bus 837 can employ a high speed parallel or serial peripheral interconnection bus of a proprietary or industry standard, such as, for example, ISA, PCI, PCI Express (PCI-e), or AGP.

The memory 840 and the non-volatile storage 845 are computer-readable storage media. The memory 840 can employ any suitable volatile storage device, such as a dynamic random access memory (DRAM) or a static RAM (SRAM). For the non-volatile storage 845, it is possible to adopt one or more of a flexible disk, a hard disk, a solid state drive (SSD), a read only memory (ROM), an erasable and programmable read only memory (EPROM), a flash memory, a compact disc (CD or CD-ROM), a digital versatile disc (DVD), a card type memory, or a stick type memory.

Furthermore, a program 848 is also a set of machine readable instructions and/or data. This set is stored in the non-volatile storage 845, and is used to create, manage, and control a specific software function explained in detail in the present disclosure and described in the drawings. Note that, in a configuration in which the memory 840 is much faster than the non-volatile storage 845, the program 848 can be transferred from the non-volatile storage 845 to the memory 840 before being executed by the processor 835.

Via the network interface 850, the computer 805 can communicate with and interact with other computers via the network 810. For the network 810, a configuration can be adopted including wired, wireless, or optical fiber connection by, for example, a local area network (LAN), a wide area network (WAN) such as the Internet, or a combination of LAN and WAN. In general, the network 810 includes any combination of connections and protocols that support communication between two or more computers and associated devices.

The peripheral interface 855 can input and output data to and from other devices that can be locally connected to the computer 805. For example, the peripheral interface 855 provides a connection to an external device 860. As the external device 860, a keyboard, a mouse, a keypad, a touch screen, and/or other suitable input devices are used. The external device 860 may also include a portable computer-readable storage medium, such as, for example, a thumb drive, a portable optical disk or a magnetic disk, or a memory card. Software and data for implementing an embodiment of the present disclosure, for example, the program 848, may be stored on such a portable computer-readable storage medium. In such an embodiment, software may be loaded onto the non-volatile storage 845, or alternatively may be loaded directly onto the memory 840 via the peripheral interface 855. The peripheral interface 855 may use an industry standard, such as RS-232 or universal serial bus (USB), to connect with the external device 860.

The display interface 865 can connect the computer 805 to a display 870, and there is a mode in which the display 870 is used to present a command line or a graphical user interface to a user of the computer 805. The display interface 865 can use one or more of dedicated connections or industry standards such as a video graphics array (VGA), a digital visual interface (DVI), DisplayPort, and high-definition multimedia interface (HDMI) (registered trademark), to connect to the display 870.

As described above, the network interface 850 provides communication with other computers and storage systems, or devices external to the computer 805. The software program and data described in this specification can be downloaded via the network interface 850 and the network 810, for example, to the non-volatile storage 845 from the remote computer 815, the web server 820, the cloud storage server 825, and the computer server 830. Moreover, the system and the method of the present disclosure can be executed by one or more computers connected to the computer 805 via the network interface 850 and the network 810. For example, in one embodiment, the system and the method of the present disclosure are executed by the remote computer 815, the computer server 830, or a combination of multiple interconnected computers on the network 810.

Data, data sets, and/or databases employed in the embodiment of the system and the method of the present disclosure can be downloaded and stored from the remote computer 815, the web server 820, the cloud storage server 825, and the computer server 830.

Here, in this specification, the processing to be performed by the computer in accordance with the program is not necessarily performed in chronological order according to the sequences described in the flowcharts. That is, the processes to be performed by the computer in accordance with the program include processes to be performed in parallel or independently of one another (such as parallel processes or object-based processes, for example).

Furthermore, the program may be processed by one computer (processor) or processed in a distributed manner by a plurality of computers. Moreover, the program may be transferred to a distant computer and executed.

Moreover, in the present description, a system means a set of a plurality of components (devices, modules (parts), and the like), and it does not matter whether or not all components are in the same housing. Therefore, a plurality of devices housed in separate housings and connected via a network and one device in which a plurality of modules is housed in one housing are both systems.

Further, for example, a configuration described as one device (or processing section) may be divided and configured as a plurality of devices (or processing sections). Conversely, configurations described above as a plurality of devices (or processing units) may be combined and configured as one device (or processing unit). Furthermore, a configuration other than the above-described configurations may be added to the configuration of each device (or each processing unit). Moreover, if the configuration and operation of the entire system are substantially the same, a part of the configuration of a certain device (or processing unit) may be included in the configuration of another device (or another processing unit).

Note that the present embodiment is not limited to the above-described embodiment, and various modifications can be made without departing from the gist of the present disclosure. The effects described in the present specification are merely examples and are not limited, and there may be other effects.

Note that the technique of the present disclosure can have the following configurations.

(1)

A processing system, including:
a task management unit that manages a plurality of media processing tasks executed in one or a plurality of servers, in which
the task management unit acquires capabilities of a plurality of servers that are possible transition destinations in a case where a media processing task executed in a first server that is one of the plurality of servers is caused to transition to a second server different from the first server, and
the capabilities include presence or absence of a persistent storage capable of storing data of the media processing task without depending on an execution state of the media processing task, and location information of the persistent storage.

(2)

The processing system according to (1) above, in which
the capabilities further include a data capacity of the persistent storage.

(3)

The processing system according to (1) or (2) above, in which
the capabilities further include a throughput and a latency with each of other servers.

(4)

The processing system according to any one of (1) to (3) above, in which
the task management unit notifies a server including the persistent storage of state recovery information storage location information that is storage location information of state recovery information for continuously executing a media processing task being executed in the first server.

(5)

The processing system according to (4) above, in which
the server including the persistent storage is the first server that is executing a media processing task that is a transition target, and
the task management unit notifies the first server of the state recovery information storage location information.

(6)

The processing system according to any one of (1) to (5) above, in which
the media processing task of the first server stores state recovery information for continuously executing the media processing task in a persistent storage a notification of which is given from the task management unit.

(7)

The processing system according to any one of (1) to (6) above, in which
the first server notifies the task management unit that the media processing task to be transitioned has stopped and of a data capacity of state recovery information for continuously executing the media processing task to be transitioned.

(8)

The processing system according to any one of (1) to (7) above, in which
the task management unit selects the second server on the basis of the acquired capabilities of the possible transition destinations in a case where the media processing task executed in the first server is caused to transition.

(9)

The processing system according to (8) above, in which
the task management unit causes the selected second server to activate in advance a same task as the media processing task executed in the first server.

(10)

The processing system according to (8) or (9) above, in which
the task management unit notifies the selected second server of state recovery information storage location information that is storage location information of state recovery information for continuously executing the media processing task to be transitioned, and instructs the selected second server to start processing of the media processing task.

(11)

The processing system according to (10) above, in which
when instructing the selected second server to start processing of a task, the task management unit gives an instruction as to whether to seamlessly continue processing of the media processing task or to perform non-continuation processing of starting processing from a predetermined start point.

(12)

The processing system according to (11) above, in which
the task management unit gives an instruction as to whether to continue processing of the media processing task or to perform non-continuation processing of starting processing from a predetermined start point on the basis of a data transfer speed between a storage location of the state recovery information and the second server and a data capacity of the state recovery information.

(13)

The processing system according to any one of (1) to (12) above, in which
the media processing task of the second server acquires, from the task management unit, state recovery information storage location information that is storage location information of state recovery information for continuously executing the media processing task to be transitioned, and a flag indicating whether to seamlessly continue processing of the media processing task to be transitioned or to perform non-continuation processing of starting processing from a predetermined start point, and executes the media processing task on the basis of the flag.

(14)

The processing system according to any one of (1) to (13) above, in which
the media processing task of the first server stores state recovery information for continuously executing the media processing task to be transitioned in a persistent storage designated by the task management unit, and
in a case where the media processing task of the transition target includes video encoding processing,
the state recovery information includes at least one of reference information of input data to be acquired next at a start of processing in a case where it is not possible to continue processing seamlessly, a picture reference structure at a time of encoding, reference information of input data to be acquired next at a time of continuing processing, reference information of output data, or a number of reference pictures necessary for continuing processing and data of each of reference pictures, and
the data of each of the reference pictures is indicated by a byte offset value from the head of entire picture data.

(15)

The processing system according to any one of (1) to (14) above, in which
the media processing task of the first server stores state recovery information for continuously executing the media processing task to be transitioned in a persistent storage designated by the task management unit, and
in a case where the media processing task of the transition target includes segment generation processing,
the state recovery information includes at least one of reference information of input data to be acquired next at a start of processing in a case where it is not possible to continue processing seamlessly, a picture reference structure of a segment, reference information of input data to be acquired next at a time of continuing processing, or processed data in the segment, and
the processed data in the segment includes a segment header being generated, a number of generated samples in the segment, and sample data.

(16)

An information processing apparatus, including:
a task management unit that manages a plurality of media processing tasks executed in one or a plurality of servers, in which
the task management unit acquires capabilities of a plurality of servers that are possible servers for executing a media processing task being executed in a first server that is one of the plurality of servers in a case where a media processing task executed in the first server is caused to transition to a second server different from the first server, and
the capabilities include presence or absence of a persistent storage capable of storing data of a task without depending on the task, and location information of the persistent storage.

(17)

An information processing method, including:
acquiring, by a task management unit of an information processing apparatus that manages a plurality of media processing tasks executed in one or a plurality of servers, capabilities of a plurality of servers that are possible servers for executing a media processing task being executed in a first server that is one of the plurality of servers in a case where a media processing task executed in the first server is caused to transition to a second server different from the first server; and
the capabilities include presence or absence of a persistent storage capable of storing data of a task without depending on the task, and location information of the persistent storage.

### REFERENCE SIGNS LIST

1 Media processing system
21 Camera
22 Terminal
23 5G network
31 (31A to 31D) Base station
32 (32A to 32D) Edge server
33 Production system
42 Server
50 Control processing system
51 Workflow management service
52(52A, 52B) Server
61(61A, 61B) Media processing task
62 Persistent storage
71 Source
72 Media FIFO
73(73A, 73B) Output destination
501 CPU
502 ROM
505 Input/output interface
506 Input unit
507 Output unit
508 Storage unit
509 Communication unit
510 Drive
511 Removable recording medium

1. A processing system, comprising:
a task management unit that manages a plurality of media processing tasks executed in one or a plurality of servers, wherein
the task management unit acquires capabilities of a plurality of servers that are possible transition destinations in a case where a media processing task executed in a first server that is one of the plurality of servers is caused to transition to a second server different from the first server, and
the capabilities include presence or absence of a persistent storage capable of storing data of the media processing task without depending on an execution state of the media processing task, and location information of the persistent storage.

2. The processing system according to claim 1, wherein
the capabilities further include a data capacity of the persistent storage.

3. The processing system according to claim 1, wherein
the capabilities further include a throughput and a latency with each of other servers.

4. The processing system according to claim 1, wherein
the task management unit notifies a server including the persistent storage of state recovery information storage location information that is storage location information of state recovery information for continuously executing a media processing task being executed in the first server.

5. The processing system according to claim 4, wherein
the server including the persistent storage is the first server that is executing a media processing task that is a transition target, and
the task management unit notifies the first server of the state recovery information storage location information.

6. The processing system according to claim 1, wherein
the media processing task of the first server stores state recovery information for continuously executing the media processing task in a persistent storage a notification of which is given from the task management unit.

7. The processing system according to claim 1, wherein
the first server notifies the task management unit that the media processing task to be transitioned has stopped and of a data capacity of state recovery information for continuously executing the media processing task to be transitioned.

8. The processing system according to claim 1, wherein
the task management unit selects the second server on a basis of the acquired capabilities of the possible transition destinations in a case where the media processing task executed in the first server is caused to transition.

9. The processing system according to claim 8, wherein
the task management unit causes the selected second server to activate in advance a same task as the media processing task executed in the first server.

10. The processing system according to claim 8, wherein
the task management unit notifies the selected second server of state recovery information storage location information that is storage location information of state recovery information for continuously executing the media processing task to be transitioned, and instructs the selected second server to start processing of the media processing task.

11. The processing system according to claim 10, wherein
when instructing the selected second server to start processing of a task, the task management unit gives an instruction as to whether to seamlessly continue processing of the media processing task or to perform non-continuation processing of starting processing from a predetermined start point.

12. The processing system according to claim 11, wherein
the task management unit gives an instruction as to whether to continue processing of the media processing task or to perform non-continuation processing of starting processing from a predetermined start point on a basis of a data transfer speed between a storage location of the state recovery information and the second server and a data capacity of the state recovery information.

13. The processing system according to claim 1, wherein
the media processing task of the second server acquires, from the task management unit, state recovery information storage location information that is storage location information of state recovery information for continuously executing the media processing task to be transitioned, and a flag indicating whether to seamlessly continue processing of the media processing task to be transitioned or to perform non-continuation processing of starting processing from a predetermined start point, and executes the media processing task on a basis of the flag.

14. The processing system according to claim 1, wherein
the media processing task of the first server stores state recovery information for continuously executing the media processing task to be transitioned in a persistent storage designated by the task management unit, and
in a case where the media processing task of the transition target includes video encoding processing,
the state recovery information includes at least one of reference information of input data to be acquired next at a start of processing in a case where it is not possible to continue processing seamlessly, a picture reference structure at a time of encoding, reference information of input data to be acquired next at a time of continuing processing, reference information of output data, or a number of reference pictures necessary for continuing processing and data of each of reference pictures, and
the data of each of the reference pictures is indicated by a byte offset value from the head of entire picture data.

15. The processing system according to claim 1, wherein
the media processing task of the first server stores state recovery information for continuously executing the media processing task to be transitioned in a persistent storage designated by the task management unit, and
in a case where the media processing task of the transition target includes segment generation processing,
the state recovery information includes at least one of reference information of input data to be acquired next at a start of processing in a case where it is not possible to continue processing seamlessly, a picture reference structure of a segment, reference information of input data to be acquired next at a time of continuing processing, or processed data in the segment, and
the processed data in the segment includes a segment header being generated, a number of generated samples in the segment, and sample data.

16. An information processing apparatus, comprising:
a task management unit that manages a plurality of media processing tasks executed in one or a plurality of servers, wherein
the task management unit acquires capabilities of a plurality of servers that are possible servers for executing a media processing task being executed in a first server that is one of the plurality of servers in a case where a media processing task executed in the first server is caused to transition to a second server different from the first server, and
the capabilities include presence or absence of a persistent storage capable of storing data of a task without depending on the task, and location information of the persistent storage.

17. An information processing method, comprising:
acquiring, by a task management unit of an information processing apparatus that manages a plurality of media processing tasks executed in one or a plurality of servers, capabilities of a plurality of servers that are possible servers for executing a media processing task being executed in a first server that is one of the plurality of servers in a case where a media processing task executed in the first server is caused to transition to a second server different from the first server; and
the capabilities include presence or absence of a persistent storage capable of storing data of a task without depending on the task, and location information of the persistent storage.
